(19) United States
(12) Patent Application Publication
(10) Pub. No.: US 2026/0367217 A1
(43) Pub. Date: Nov. 19, 2026

(54) DETERMINATION DEVICE, DETERMINATION METHOD, DETERMINATION PROGRAM, AND RADAR DEVICE

(71) Applicant: SONY SEMICONDUCTOR SOLUTIONS CORPORATION, KANAGAWA (JP)

(72) Inventor: RYO SASAKI, KANAGAWA (JP)

(21) Appl. No.: 19/477,724

(22) PCT Filed: Apr. 17, 2024
(86) PCT No.: PCT/JP2024/015223

§ 371 Date: Oct. 22, 2025

(30) Foreign Application Priority Data
May 15, 2023 (JP) 2023-080160

(51) Int. Cl. G01S 7/02; G01S 15/06

(52) U.S. Cl. CPC G01S 7/023; G01S 15/06

(57) ABSTRACT

[Object] To provide a determination device, determination method, determination program, and radar device that make it possible to determine whether radio wave interference is present without preparing the special mode for the radio wave interference or without increasing the noise floor even when the radio wave interference is present.

[Solving Means] A determination device according to an embodiment of the present technology includes a reception section and a determination process section. The reception section receives a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted. The determination process section compares a plurality of angle-of-arrival spectra generated on the basis of a plurality of corrected signals obtained by performing a plurality of speed folding correction processes on the first reflection chirp signal and the second reflection chirp signal, and determines whether or not an unwanted

### TECHNICAL FIELD

The present technology relates to a determination device, determination method, determination program, and radar device that determine whether unwanted waves are generated such as radio wave interference of a frequency modulated continuous wave (FMCW) radar.

### BACKGROUND ART

In a multi input multi output (MIMO) radar, a plurality of transmission antennas transmits chirp signals in groups called bursts. A reception antenna receives the reflected chirp signal. The received signal is downconverted, digitized, and then processed to obtain distances, speeds, and angles of arrival of a plurality of objects in front of the radar. The chirp signal is a signal whose frequency varies linearly over time.

However, for example, sometimes the radio wave interference may be caused with a radar system or the like installed in an oncoming car when detecting the distances, speeds, and angles of arrival of the plurality of objects in front of the radar. In a case of using coded transmission waves to reduce false peaks due to the radio wave interference, it is possible to reduce the false peaks, but there is a problem that a noise floor increases.

With regard to the above-described problem, Patent Literature 1 discloses a radar system 1 that generates a prevention signal by performing an interference removal process of suppressing effects of radio wave interference with respect to a non-prevention signal acquired from a radar sensor, that performs a frequency analysis process using the prevention signal when a set operation mode is an interference mode, or using the non-prevention signal when the operation mode is a normal mode, and that determines whether radio wave interference is present.

### CITATION LIST

### Patent Literature

Patent Literature 1: Japanese Patent No. 6648710B

### DISCLOSURE OF INVENTION

### Technical Problem

However, if using Patent Literature 1, it is necessary to additionally prepare a special mode for the radio wave interference, and this deteriorates its efficiency.

In view of the circumstances as described above, a purpose of the present technology is to provide a determination device, determination method, determination program, and radar device that make it possible to determine whether radio wave interference is present without preparing the special mode for the radio wave interference or without increasing the noise floor even when the radio wave interference is present.

### Solution to Problem

A determination device according to an embodiment of the present technology includes a reception section and a determination process section. The reception section receives a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted. The determination process section generates a plurality of angle-of arrival spectra on the basis of a plurality of corrected signals obtained by performing a plurality of speed folding correction processes on the first reflection chirp signal and the second reflection chirp signal that have been received by the reception section, compares the plurality angle-of-arrival spectra with each other, and determines whether or not an unwanted signal is received.

According to the embodiment, it is possible to determine whether or not the unwanted signal is received, by receiving the first reflection chirp signal reflected by the object and the second reflection chirp signal that is different from the first transmission chirp signal, generating the plurality of angle-of-arrival spectra on the basis of the plurality of corrected signals obtained by performing the plurality of speed folding correction processes on the first reflection chirp signal and the second reflection chirp signal, comparing the plurality angle-of-arrival spectra with each other, and determining whether or not the unwanted signal is received. In other words, it is possible to determine whether or not the unwanted signal is received by comparing the plurality angle-of-arrival spectra with each other. This makes it possible to determine whether radio wave interference is present without preparing the special mode for the radio wave interference or without increasing the noise floor even when the radio wave interference is present.

The determination process section may include a beat signal generation section configured to generate a first beat signal on the basis of the first transmission chirp signal and the first reflection chirp signal, and generate a second beat signal on the basis of the second transmission chirp signal and the second reflection chirp signal.

The determination process section may include a transform process section configured to generate a first distance speed signal including a first distance signal related to a distance to the object and a first speed signal related to speed of the object by executing a Fourier transform process on the basis of the first reflection chirp signal, and a second distance speed signal including a second distance signal related to a distance to the object and a second speed signal related to speed of the object by executing the Fourier transform process on the basis of the second reflection chirp signal.

The determination process section may include a determination section configured to determine that the unwanted signal does not exist in a case where the plurality angle-of-arrival spectra includes only one angle-of-arrival spectrum having second peak intensity that is a predetermined intensity or less with respect to first peak intensity, and determine that the unwanted signal exists in a case where the plurality of angle-of-arrival spectra includes a plurality of angle-of-arrival spectra having the second peak intensities that are the predetermined intensity or less with respect to the first peak intensity and in a case where the plurality of angle-of-arrival spectra does not include the angle-of-arrival spectrum having the second peak intensity that is the predetermined intensity or less with respect to the first peak intensity, the first peak intensity achieving maximum reception intensity with respect to angles of arrival of the first reflection chirp signal and the second reflection chirp signal, the second peak achieving a second highest reception intensity after the first peak.

The unwanted signal may be an interference signal transmitted from another transmission device different from the transmission device.

The unwanted signal may be a signal obtained when the first transmission chirp signal transmitted from the transmission device is reflected by the object and also reflected by another object different from the object.

A determination method according to an embodiment of the present technology includes: receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and generating a plurality of angle-of-arrival spectra on the basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.

A determination program according to an embodiment of the present technology includes: a step of receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and a step of generating a plurality of angle-of-arrival spectra on the basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.

A radar device according to an embodiment of the present technology includes a transmission device and a determination device. The transmission device transmits a first transmission chirp signal and a second transmission chirp signal that is emitted at a different time from when the first transmission chirp signal is emitted, toward an object. The determination device includes a reception section and a determination process section. The reception section receives a first reflection chirp signal obtained when the object reflects the first transmission chirp signal, and a second reflection chirp signal obtained when the object reflects the second transmission chirp signal. The determination process section generates a plurality of angle-of-arrival spectra on the basis of a plurality of corrected signals obtained by performing a plurality of speed folding correction processes on the first reflection chirp signal and the second reflection chirp signal that have been received by the reception section, compares the plurality angle-of-arrival spectra with each other, and determines whether or not an unwanted signal is received.

The transmission device may include a first transmission antenna configured to transmit the first transmission chirp signal and a second transmission antenna configured to transmit the second transmission chirp signal.

The transmission device may include a transmission antenna configured to transmit the first transmission chirp signal and the second transmission chirp signal in a time-division manner.

The transmission device may include a transmission antenna configured to transmit the first transmission chirp signal and the second transmission chirp signal in a phase-division manner.

### BRIEF DESCRIPTION OF DRAWINGS

FIG. 1 is a block diagram illustrating a configuration of a radar device used in a present embodiment of the present technology.

FIG. 2 is a diagram schematically illustrating a concept of horizontal MIMO.

FIG. 3 is a diagram schematically illustrating a concept of vertical MIMO.

FIG. 4 is a diagram schematically illustrating a concept of TDM-MIMO.

FIG. 5 is a diagram schematically illustrating a concept of speed phase error of TDM-MIMO.

FIG. 6 is a diagram schematically illustrating a concept of speed phase error correction of TDM-MIMO.

FIG. 7 is a diagram schematically illustrating a concept of limitation of speed phase correction due to speed ambiguity.

FIG. 8 is a diagram schematically illustrating a concept of speed phase error correction due to speed ambiguity.

FIG. 9 is a diagram schematically illustrating correction of a phase difference due to speed ambiguity.

FIG. 10 is a diagram schematically illustrating a spectrum subjected to the correction of the phase difference due to speed ambiguity. (A) illustrates a spectrum whose residual speed error remains after speed phase correction with ω=0/TB. (B) illustrates a spectrum whose speed error is corrected after speed phase correction with 2πn/TB.

FIG. 11 is a diagram schematically illustrating a transmission signal.
(A) illustrates a transmission signal and a reception signal.
(B) illustrates a state where one pulse of parallel interference invades.
(C) illustrates a state where a timing synchronization signal of parallel interference invades.

FIG. 12 is a diagram illustrating a folding correction process performed in a case of FIG. 11(A).

FIG. 13 illustrates angle-of-arrival spectra obtained in a case where no unwanted signal exists.
(A) illustrates a correct spectrum.
(B) illustrates a false spectrum.

FIG. 14 is a diagram illustrating a process performed by a determination process section in a case of FIG. 11(B).
(A) illustrates a folding correction process.
(B) illustrates an angle-of-arrival spectrum.

FIG. 15 is a diagram illustrating a process performed by the determination process section in a case of FIG. 11(C).
(A) illustrates the folding correction process.
(B) illustrates an angle-of-arrival spectrum.

FIG. 16 is a flowchart illustrating a process procedure of determination of the unwanted signal according to the present embodiment.

FIG. 17 is a diagram illustrating a process procedure according to a modification.

FIG. 18 is a block diagram illustrating a configuration example of a vehicle control system.

FIG. 19 is a diagram illustrating an example of a sensing region.

### MODE(S) FOR CARRYING OUT THE INVENTION

Hereinafter, embodiments of the present technology will be described with reference to the drawings.

### Present Embodiment

### Radar Device

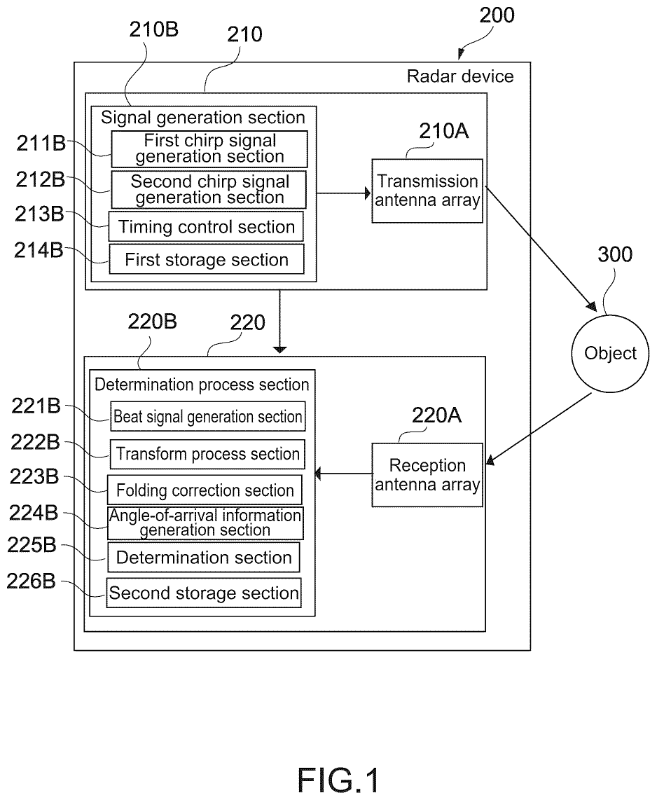

FIG. 1 is a block diagram illustrating a configuration of a radar device 200 used in an embodiment of the present technology. The radar device 200 includes a transmission device 210 and a determination device 220. The transmission device 210 includes a transmission antenna array 210A and a signal generation section 210B. Next, configurations of these devices will be described.

The transmission antenna array 210A includes a plurality of transmission antennas, each of which transmits a plurality of chirp signals. The transmission antenna array 210A and a reception antenna array 220A constitute horizontal MIMO or vertical MIMO. Here, the reception antenna array 220A includes a plurality of reception antennas that receive a plurality of chirp signals reflected by an object 300.

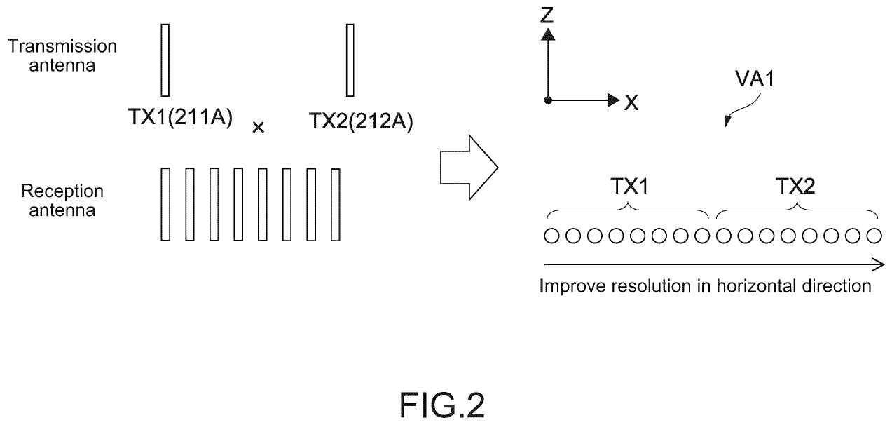

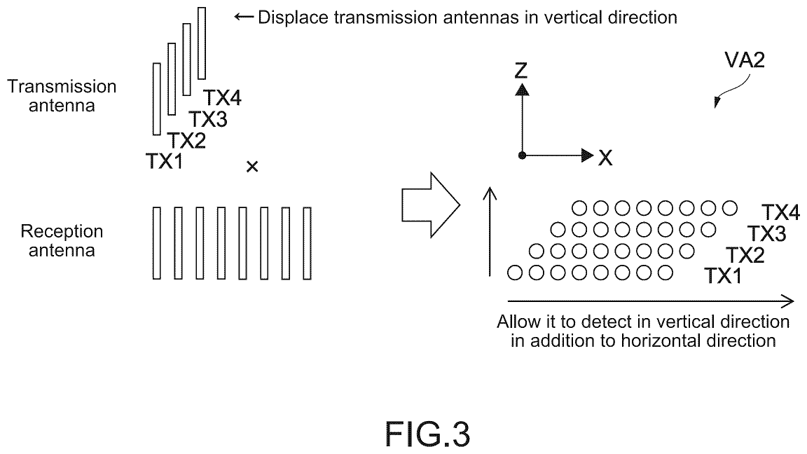

FIG. 2 schematically illustrates a concept of the horizontal MIMO. FIG. 3 schematically illustrates a concept of the vertical MIMO.

The above-described MIMO is a method of virtually increasing an opening length (~reception area of antenna) by spatially displacing a plurality of (two in this example) transmission antennas (first transmission antenna 211A and second transmission antenna 212A) with respect to a plurality of (eight in this example) reception antennas. Displacing the plurality of transmission antennas in a horizontal direction improves resolution in the horizontal direction (see FIG. 2). VAI represents a virtual array and various kinds of combinations of the reception antennas and the transmission antennas. More specifically, with regard to the virtual array, the MIMO including the plurality of transmission antennas and the plurality of reception antennas is considered as virtual single-input multiple-output (SIMO) that is an mathematically equivalent antenna array, and it is assumed that the number of the transmission antennas is one and the number of the reception antennas is a value obtained by (the number of transmission antennas×the number of reception antennas). Displacing the plurality of transmission antennas in a vertical direction allows detection in the vertical direction in addition to the horizontal direction (see FIG. 3). Like VA1, VA2 represents a virtual array and various kinds of combinations of the reception antennas and the transmission antennas.

The signal generation section 210B has a function of generating a plurality of chirp signals to be transmitted from the above-described transmission antenna array 210A. The signal generation section 210B includes a first chirp signal generation section 211B, a second chirp signal generation section 212B, a timing control section 213B, and a first storage section 214B. The first storage section 214B is an information storage device such as a semiconductor memory or a hard disk. The first storage section 214B stores a program for operating the signal generation section 210B.

The first chirp signal generation section 211B generates a first transmission chirp signal TX1 to be transmitted from the above-described first transmission antenna 211A. The second chirp signal generation section 212B generates a second transmission chirp signal TX2 to be transmitted from the above-described second transmission antenna 212A. Here, the word “generate” means not only to just generate the chirp signal but also means to transmit the chirp signal. In addition, the first chirp signal generation section 211B also transmits the transmitted first transmission chirp signal TX1 to the determination process section 220B. This makes it possible to generate a beat signal (to be described later). In a way similar to the first chirp signal generation section 211B, the second chirp signal generation section 212B also transmits the transmitted second transmission chirp signal TX2 to the determination process section 220B.

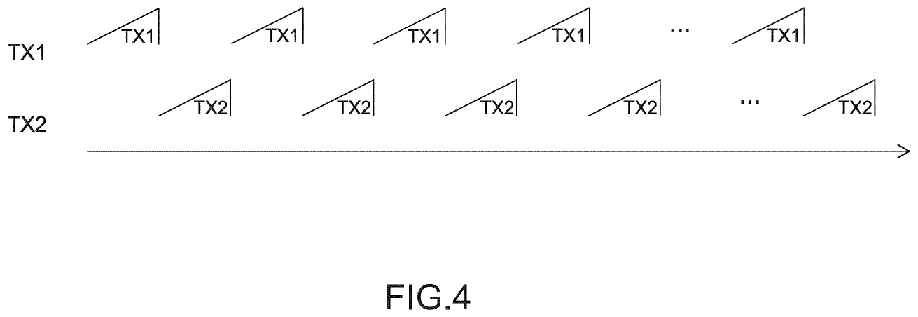

The timing control section 213B controls timings of generating (transmitting) the first transmission chirp signal TX1 and the second transmission chirp signal TX2 toward an outside (object 300). In general, to achieve a MIMO radar, time-division multiplexing (TDM)-MIMO is often used as a method of transmitting chirp signals. FIG. 4 schematically illustrates a concept of the TDM-MIMO.

In the TDM-MIMO, chirp signals to be transmitted from transmission antennas forming MIMO are transmitted in a time-division manner by the number of transmission antennas. For example, in MIMO with two transmission antennas, the two transmission antennas alternately transmit the chirp signals TX1 and TX2. Here, there is a time lag between the transmission timings of the first transmission chirp signal TX1 and the second transmission chirp signal TX2 from the two transmission antennas (first transmission antenna 211A and second transmission antenna 212A). Therefore, in a case where a target has speed (e.g., oncoming vehicle), a phase shift occurs between a reception signal (first reflection chirp signal RX1 to be described later) formed by the first transmission chirp signal TX1 transmitted from the first transmission antenna 211A and a reception signal (second reflection chirp signal RX2 to be described later) formed by the second transmission chirp signal TX2 transmitted from the second transmission antenna 212A, due to speed and time shifts. As will be described later, by correcting the phase shift, it becomes possible to calculate a distance between the object 300 and a reception section 220A (determination device 220 and radar device 200), speed (or relative speed), or an angle of arrival of the object 300 with respect to the reception section 220A (determination device 220 and radar device 200).

It is also possible for the timing control section 213B to control timings of generating (transmitting) the first transmission chirp signal TX1 and the second transmission chirp signal TX2 toward the determination process section 220B. In other words, for example, the timing control section 213B may transmit the first transmission chirp signal TX1 and the second transmission chirp signal TX2 to the outside and a beat signal generation section 221B. It is possible for the beat signal generation section 221B to determine whether the transmitted signal is the first transmission chirp signal TX1 or the second transmission chirp signal TX2 from a timing of transmission from the signal generation section 210B, for example.

The determination device 220 includes the reception antenna array (reception section) 220A and the determination process section 220B. As described above, the reception antenna array 220A receives the first reflection chirp signal RX1 obtained when the object 300 reflects the first transmission chirp signal TX1, and the second reflection chirp signal RX2 obtained when the object 300 reflects the second transmission chirp signal TX2. In the present embodiment, the reception antenna array 220A includes eight reception antennas. Of course, the number of reception antennas included in the reception antenna array 220A is not limited to 8 but may be 10, for example.

The determination process section 220B has a function of determining whether an unwanted signal exists in a reflection chirp signal obtained when the object 300 reflects a transmission chirp signal. The determination process section 220B includes the beat signal generation section 221B, a transform process section 222B, a folding correction section 223B, an angle-of-arrival information generation section 224B, a determination section 225B, and a second storage section 226B. The second storage section 226B is an information storage device such as a semiconductor memory or a hard disk. The second storage section 226B stores a program for operating the determination process section 220B.

The beat signal generation section 221B generates beat signals on the basis of the reflection chirp signals and the transmission chirp signals transmitted from the first chirp signal generation section 211B and the second chirp signal generation section 212B. The beat signal is a signal obtained by mixing the reflection chirp signal and the transmission chirp signal and setting a difference in frequency between the reflection chirp signal and the transmission chirp signal as a frequency component. The beat signal is also referred to as an intermediate frequency (IF) signal. In other words, the beat signal generation section 221B according to the present embodiment generates a first beat signal IF1 by mixing the first reflection chirp signal RX1 and the first transmission chirp signal TX1 transmitted from the first chirp signal generation section 211B, and generates a second beat signal IF2 by mixing the second reflection chirp signal RX2 and the second transmission chirp signal TX2 transmitted from the second chirp signal generation section 212B.

The transform process section 222B generates a distance speed signal by executing a Fourier transform (fast Fourier transform (FFT) or discrete Fourier transform (DFT) ) of a distance axis and a speed axis on the basis of the reflection chirp signal. The distance speed signal includes distance information related to a distance from the reception section 220A (determination device 220) to the object 300 and speed information related to a speed (or relative speed) of the object. The distance speed signal is represented as a graph in which distance bins are in an X-axis direction, speed bins are in a Y-axis direction perpendicular to the X-axis direction, and signal intensity is in a Z-axis direction perpendicular to the X-axis and the Y-axis. In other words, a distance to the object 300 and a speed (or relative speed) of the object 300 are calculated on the basis of signal intensity of the distance speed signal.

The transform process section 222B according to the present embodiment generates a first distance speed signal D1 including first distance information related to a distance from the reception section 220A (determination device 220 and radar device 200) to the object 300 and first speed information related to a speed (or relative speed) of an object 2 by executing the Fourier transform on the basis of the first beat signal IF1, and generates a second distance speed signal D2 including second distance information related to a distance from the reception section 220A (determination device 220 and radar device 200) to the object 2 and second speed information related to a speed (or relative speed) of the object 2 by executing the Fourier transform on the basis of the second beat signal IF2.

The folding correction section 223B carries out a process of performing a speed folding correction process with regard to the distance speed signals.

The folding correction section 223B according to the present embodiment executes a correction process with the number of times of speed folding=0 with regard to the first distance speed signal D1 and the second distance speed signal D2, and generates a first corrected signal H1 that is virtually arrayed. In addition, the folding correction section 223B also executes the correction process corresponding to 1 times of speed folding with regard to the first distance speed signal D1 and the second distance speed signal D2, and generates a second corrected signal H2 that is virtually arrayed. Details of the speed folding correction process will be described later.

In addition, the angle-of-arrival information generation section 224B generates an angle-of-arrival spectrum S1 by executing the Fourier transform with 21 regard to the first corrected signal H1. The angle-of-arrival information generation section 224B also generates an angle-of-arrival spectrum S2 by executing the Fourier transform with regard to the second corrected signal H2.

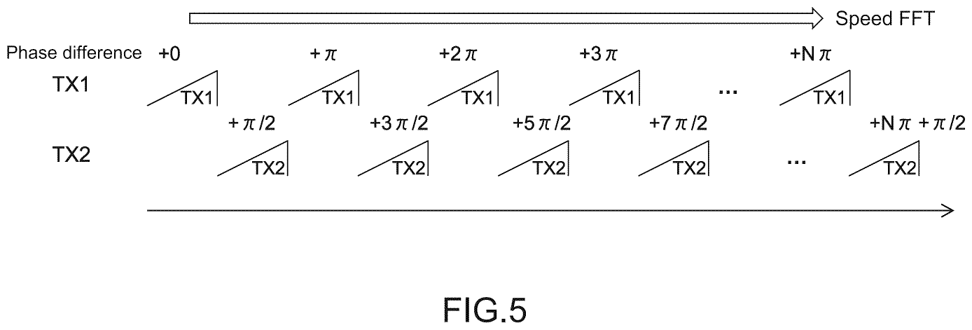

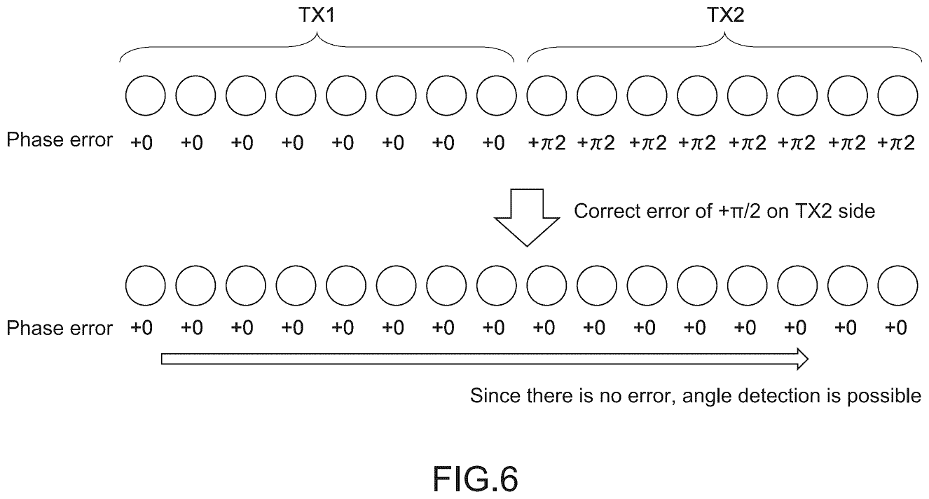

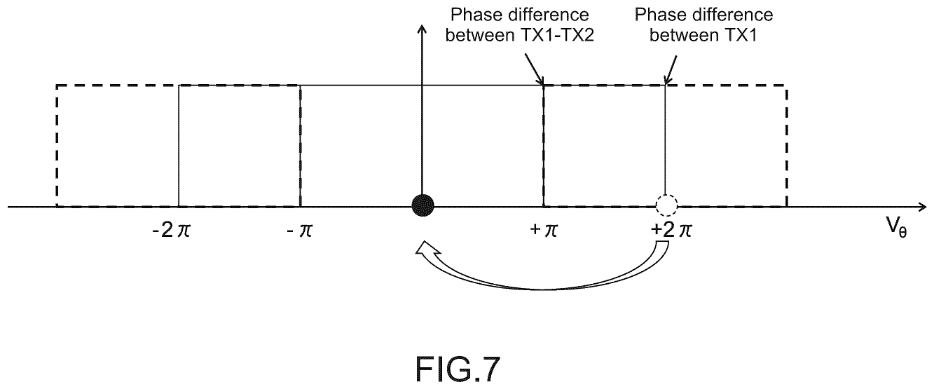

Here, process procedures of the speed folding correction process and a process performed by the angle-of-arrival information generation section 224 will be described. FIG. 5 schematically illustrates a concept of speed phase error of the TDM-MIMO. FIG. 6 schematically illustrates a concept of speed phase error correction of the TDM-MIMO. FIG. 7 schematically illustrates a concept of limitation of speed phase correction due to speed ambiguity.

The speed of the target can be calculated by performing fast Fourier transform (FFT) (speed FFT) in the chirp direction on each of the chirp signals TX1 and TX2 after separating the chirp signals multiplexed between the plurality of transmission antennas in the TDM-MIMO for each transmission antenna. Further, the speed FFT is capable of detecting the phase lead and lag due to the speed. In the example illustrated in FIG. 5, the phase advances by +π between the plurality of chirp signals TX1 from the first transmission antenna 211A due to the speed. In a case where the phase difference between the plurality of chirp signals TX1 from the first transmission antenna 211A due to the speed is +π as illustrated in FIG. 5, the phase of the chirp signals TX1 from the first transmission antenna 211A and the phase of the chirp signals TX2 from the second transmission antenna 212A are shifted by +π/2 (i.e., the phase error between TX1 and TX2 is +π/2).

For this reason, correcting the phase of the chirp signals TX2 from the second transmission antenna 212A by −n/2 eliminates the phase difference between the chirp signals TX1 from the first transmission antenna 211A and the chirp signals TX2 from the second transmission antenna 212A. Even in a case where the target has a speed, the phase error between the chirp signals TX1 from the first transmission antenna 211A and the chirp signals TX2 from the second transmission antenna 212A can be corrected in this way.

As described with reference to FIG. 5, when the phase difference between the plurality of chirp signals TX1 from the first transmission antenna 211A is +π and the phase error between TX1 and TX2 is +π/2, correcting the phase of the chirp signals TX2 from the second transmission antenna 212 A by −π/2 eliminates the error between the chirp signals TX1 and TX2, and this makes it possible to perform angle detection.

In accordance with a sampling theorem, the phase difference by the speed FFT can be detected only 23 from −-90 -0 to +π. However, in practice, the phase due to the speed exceeds +π in some cases. For example, if a phase difference between chirps of the plurality of chirp signals TX1 from the first transmission antenna 211A is +2π, the phase difference of +2π folds to +0 when the FFT is performed.

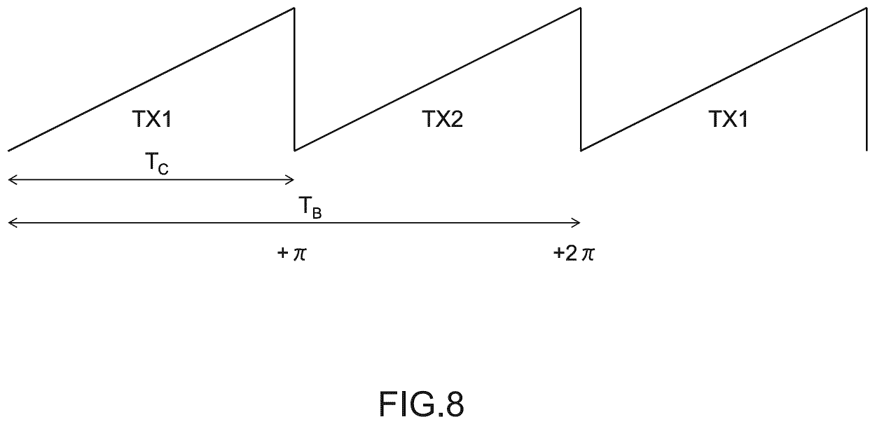

FIG. 8 schematically illustrates a concept of speed phase correction due to speed ambiguity.

Typically, chirp signals are transmitted such that transmission timings of the respective chirp signals TX are equally spaced with respect to a burst interval TB. The burst interval TB is an interval between the plurality of chirp signals from a same antenna when separating the chirp signals multiplexed between the transmission antennas for each transmission antenna. That is, the first transmission chirp signal TX1 from the first transmission antenna 211A and the second chirp signal TX2 from the second transmission antenna 212A are transmitted at timings of 0 [μs] and TBx1/2 [μs], respectively, with an equidistant interval. Assuming that chirp intervals Tc are equally spaced, an angular velocity w is obtained by a formula (1).

ω=φ/(Ntx·Tc)=φ/TB[rad./s] (1)

As represented by the formula (1), when an angular velocity ω=2π/TB, the phase moves by +2π in the burst interval TB. Therefore, the phase moves by +π in the chirp interval Tc.

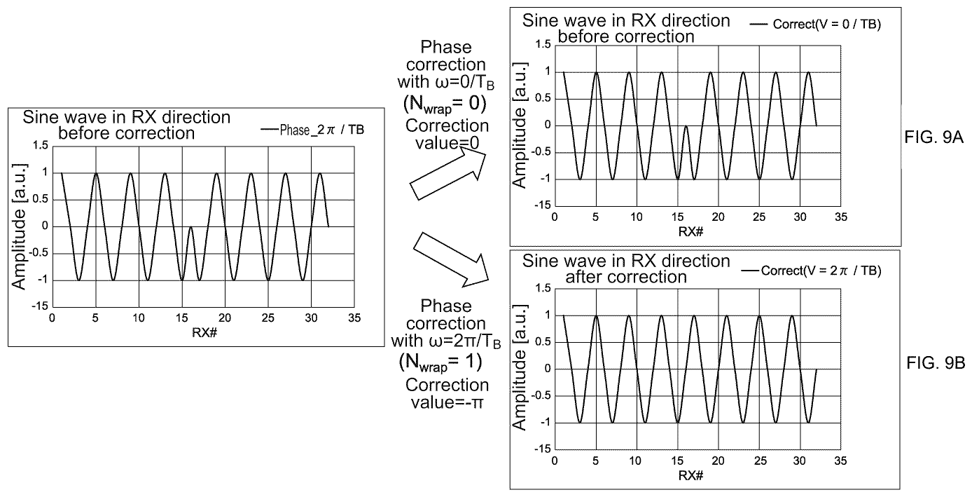

FIG. 9 schematically illustrates correction of a phase difference due to speed ambiguity.

In a case where angular velocity of the chirp signals TX1 and TX2 from the two transmission antennas satisfies ω=2π/TB, the phase difference between the chirp signals TX1 and TX2 is π. However, angular velocity ω=0/TB is detected. As illustrated in FIG. 9(A), the correction value =0 is obtained in a case where the phase is corrected (speed folding correction process) assuming that ω=0/TB and the number of times of speed folding Nwrap=0. At this time, the phase difference between the chirp signals TX1 and TX2 is not corrected. As illustrated in FIG. 9(B), the correction value =−π is obtained in a case where the phase is corrected (speed folding correction process) assuming that ω=2π/TB and the number of times of speed folding Nwrap=1. At this time, the phase difference between the chirp signals TX1 and TX2 is corrected.

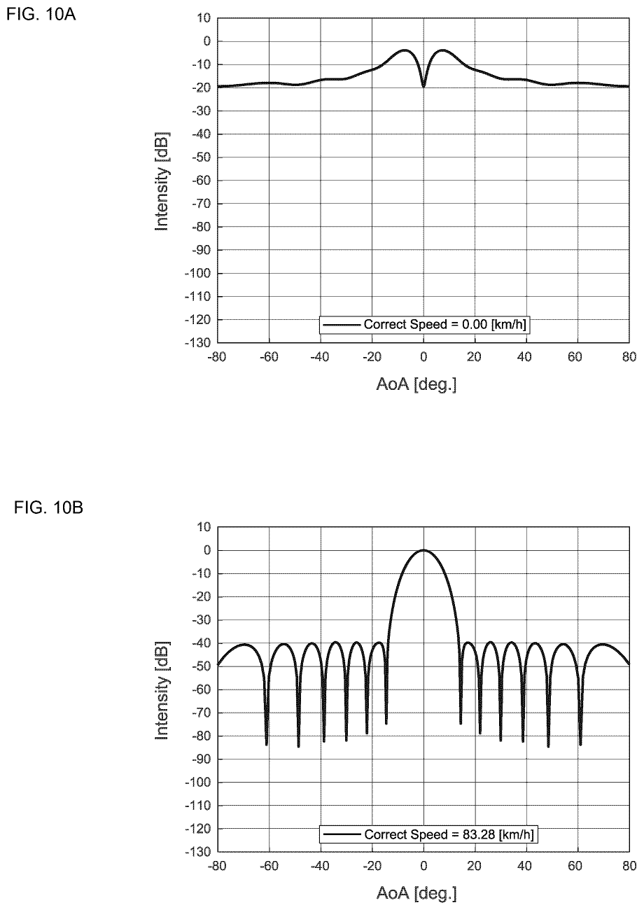

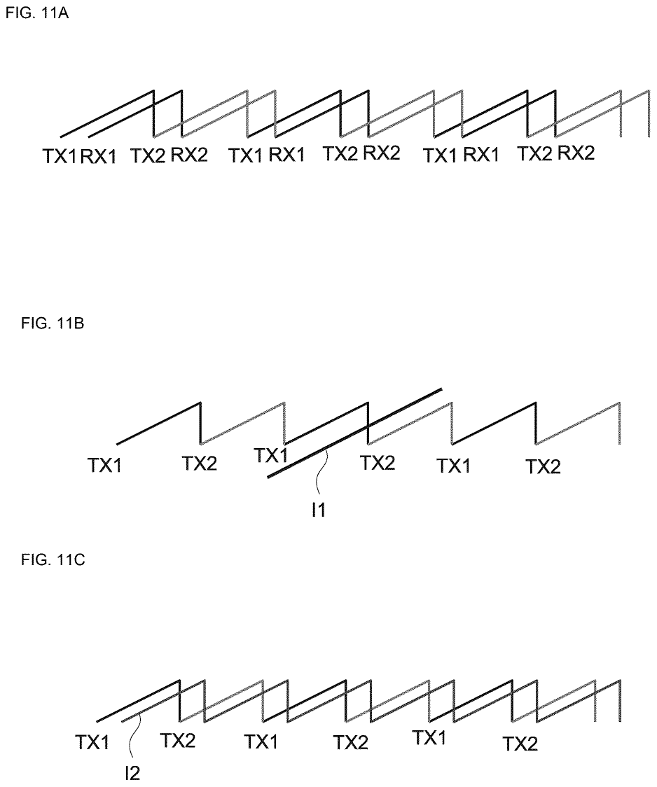

FIG. 10 illustrates angle-of-arrival spectra corresponding to FIG. 9(A) and FIG. 9(B). Only when the phase difference between the chirp signals TX1 and TX2 is corrected, a main lobe of the angle-of-arrival (AoA) spectrum achieves its maximum value and a ratio between the main lobe and side lobes becomes maximum.

As described above, by utilizing the reduction in electric power due to directivity deviation (false speed) caused by a speed phase difference between transmission antennas in the MIMO, MIMO speed phase correction and AoA are performed on the plurality of possible speeds to decide a speed candidate with larger electric power as a true speed.

By expanding the speed, the true speed can be detected even if the speed folds. In addition, reduction in electric power, occurrence of ghosts, misdetection, and the like can be prevented by knowing the true speed.

As described above, it is possible to find accurate speed by detecting folding through the speed folding correction process, correcting a result of the FFT, and calculating the angle-of-arrival spectra. This process makes it possible to decide correct speed in a case where a received signal is a signal reflected by the target and has an angle of arrival uniquely derived.

In addition, the determination section 225B determines whether the unwanted signal exists from the plurality of angle-of-arrival spectra generated by the angle-of-arrival information generation section 224B and the folding correction section 223B. Here, the unwanted signal is an interference signal transmitted from another transmission device (for example, transmission device of oncoming vehicle) different from the transmission device 210. In this embodiment, parallel interference (constant interference, approach interference) is assumed. Here, details of the parallel interference will be described. FIG. 11 is a diagram schematically illustrating a transmission signal. FIG. 11(A) illustrates the transmission chirp signals TX1 and TX2 and the reception signals RX1 and RX2. FIG. 11(B) illustrates a state where one pulse I1 of parallel interference invades. FIG. 11(C) illustrates a state where a timing synchronization signal I2 of parallel interference invades.

As illustrated in FIG. 11(B) and FIG. 11(C), the parallel interference includes interference between other FMCW radars having almost same frequency sweep timings. In other words, as illustrated in FIG. 11(B) and FIG. 11(C), the parallel interference is interference caused when a signal invade, the signal having almost same slope as frequencies of the transmission chirp signals TX1 and TX2 transmitted from the transmission device 210.

In addition, examples of the unwanted signal include multipath that is a phenomenon that reception waves from a same object are detected in a plurality of paths when a radar wave is reflected by a road surface, wall surface, or the like. In other words, the determination section 225B determines whether parallel interference or interference (unwanted signal) due to the multipath is occurred.

Next, the determination section 225B determines (first determination) that the unwanted signal does not exist in a case where the plurality angle-of-arrival spectra includes only one angle-of-arrival spectrum having second peak intensity that is a predetermined intensity or less with respect to first peak intensity, and determines (second determination) that the unwanted signal exists in a case where the plurality of angle-of-arrival spectra includes a plurality of angle-of-arrival spectra having the second peak intensities that is the predetermined intensity or less with respect to the first peak intensity, or determines (third determination) that the unwanted signal exists in a case where the plurality of angle-of-arrival spectra does not include the angle-of-arrival spectra having the second peak intensity that is the predetermined intensity or less with respect to the first peak intensity, the first peak intensity achieving maximum reception intensity with respect to angles of arrival of the reflection chirp signals, the second peak achieving a second highest reception intensity after the first peak. In other words, it is determined that the signal is a normal reception signal in a case where the number of speed folding that properly corrects the phase difference between the chirp signals TX1 and TX2 uniquely exists, or for the reflection signal that behaves unlike a normal reflection signal from the target, such as in a case where the number of speed folding that makes the proper correction does not exists or the presence of a plurality of the number of speed folding that makes the proper correction, it is determined that the signal is aliasing due to the interference or a signal caused by unwanted reflection.

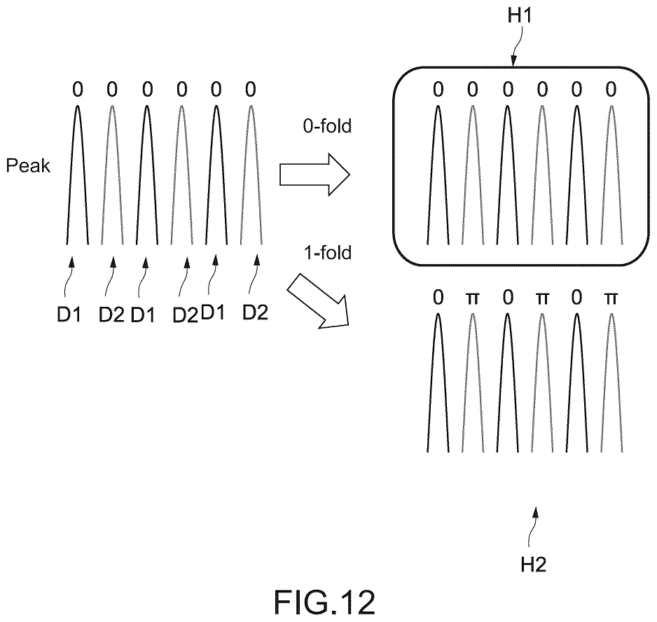

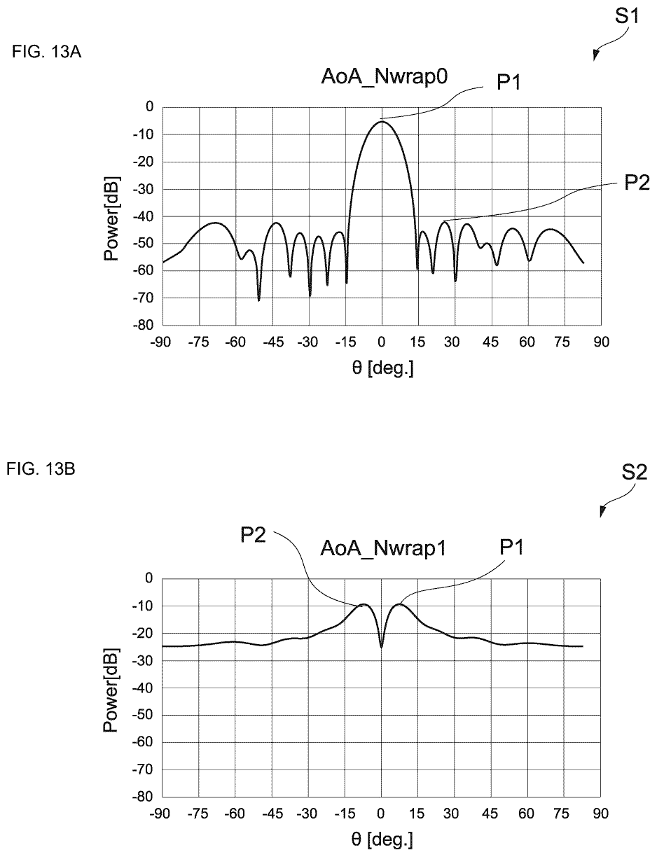

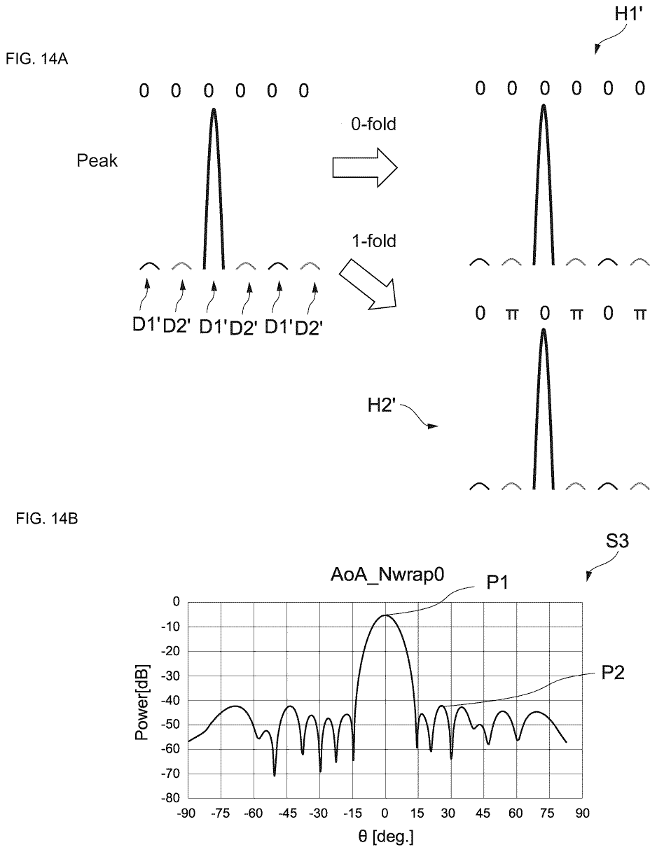

Here, details of the first determination will be described. FIG. 12 is a diagram illustrating a folding correction process performed in a case of FIG. 11(A). In addition, FIG. 13 illustrates angle-of-arrival spectra obtained in a case where no unwanted signal exists. FIG. 13(A) illustrates a correct spectrum. FIG. 13(B) illustrates a false spectrum.

FIG. 12 illustrates a first corrected signal H1 and a second corrected signal H2. The first corrected signal H1 is obtained when the speed folding correction process is performed on the first distance speed signal D1 and the second distance speed signal D2 while setting the number of times of speed folding Nwrap=0. The second corrected signal H2 is obtained when the speed folding correction process is performed on the first distance speed signal D1 and the second distance speed signal D2 while setting the number of times of speed folding Nwrap=1. Here, “0” and “π” illustrated in FIG. 12 indicate phase components corresponding to the shift and use radian as their unit. Therefore, there is no phase shifting between the first distance speed signal D1 and the second distance speed signal D2. With regard to the second corrected signal H2 subjected to the speed folding correction process with the number of times of speed folding Nwrap=1, the phase of the signals corresponding to the second distance speed signal D2 is shifted by π. Hereinafter, the same applies to numerals and signs illustrated in FIG. 14 and FIG. 15.

A first angle-of-arrival spectrum S1 illustrated in FIG. 13(A) is a spectrum obtained in a case where the AoA (Fourier transform) is performed on the first corrected signal H1 illustrated in FIG. 12. A second angle-of-arrival spectrum S2 illustrated in FIG. 13(B) is a spectrum obtained in a case where the AoA (Fourier transform) is performed on the second corrected signal H2 illustrated in FIG. 12.

As illustrated in FIG. 13(A), a correct spectrum is an angle-of-arrival spectrum having a second peak P2 that is a predetermined value or less with respect to intensity (dB) of a first peak P1. Also, as illustrated in FIG. 13(B), a false spectrum is an angle-of-arrival spectrum having the second peak (P2) that is not the predetermined value or less with respect to the intensity (dB) of the first peak P1.

Here, for example, “predetermined value or less” means that it is less than reception intensity of the first peak P1 by 30 dB. Of course, it is not limited to 30 dB but may be 10 dB, 40 dB, or the like. Also, the present technology is not limited thereto. It may be a half or less of the reception intensity of the first peak P1 such as one-third or less.

Therefore, on the basis of the first determination according to the present embodiment, only the first angle-of-arrival spectrum S1 in FIG. 13(A) has the second peak P whose intensity is a predetermined intensity or less than the intensity of the first peak P1 achieving the maximum reception intensity among the two angle-of-arrival spectra in FIG. 13(A) and FIG. 13(B). Accordingly, it is determined that the unwanted signal does not exists.

Next, details of the second determination will be described. FIG. 14 is a diagram illustrating a process performed by a determination process section 220B in a case of FIG. 11(B). FIG. 14(A) illustrates a folding correction process. FIG. 14(B) illustrates a third angle-of-arrival spectrum S3.

FIG. 14 illustrates a first corrected signal H1′ and a second corrected signal H2′. The first corrected signal H1′ is obtained when the speed folding correction process is performed on a first distance speed signal D1′ and a second distance speed signal D2′ while setting the number of times of speed folding Nwrap=0. The second corrected signal H2′ is obtained when the speed folding correction process is performed on the first distance speed signal Dl′ and the second distance speed signal D2′ while setting the number of times of speed folding Nwrap=1.

The third angle-of-arrival spectrum S3 illustrated in FIG. 14(B) is a spectrum obtained in a case where the number of times of speed folding is zero and 1, and its shape barely changes. Here, “barely changes” means that its peak intensity or spectrum shape do not change (for example, more than 60% of its shape matches).

The third angle-of-arrival spectrum S3 illustrated in FIG. 14(B) is in a state where the one pulse I1 invades as illustrated in FIG. 11(B). Therefore, its spectrum shape barely changes even if the speed folding correction process is performed (that is, the invasion by the one pulse I1 partially increases its peak intensity, and no change is seen in its shape even when the phase is rotated).

Therefore, on the basis of the second determination according to the present embodiment, the third angle-of-arrival spectrum S3 illustrated in FIG. 14(B) has similar shapes between a case where the number of times of speed folding is zero and a case where the number of times of speed folding is 1. This means that there is a plurality of angle-of-arrival spectra having the second peak P2 whose intensity is a predetermined intensity or less than the intensity of the first peak P1. Accordingly, it is determined that the unwanted signal (one pulse I1) exists.

Next, details of the third determination will be described. FIG. 15 is a diagram illustrating a process performed by the determination process section 220B in a case of FIG. 11(C). FIG. 15(A) illustrates a folding correction process. FIG. 15(B) illustrates a fourth angle-of-arrival spectrum S4.

FIG. 15(A) illustrates a first corrected signal H1″ and a second corrected signal H2″. The first corrected signal H1″ is obtained when the speed folding correction process is performed on a first distance speed signal D1″ and a second distance speed signal D2″ while setting the number of times of speed folding Nwrap=0. The second corrected signal H2″ is obtained when the speed folding correction process is performed on the first distance speed signal D1″ and the second distance speed signal D2″ while setting the number of times of speed folding Nwrap=1.

The fourth angle-of-arrival spectrum S4 illustrated in FIG. 15(B) is obtained when the speed folding correction process is performed on the first distance speed signal D1″ and the second distance speed signal D2″ while setting the number of times of speed folding Nwrap =0 and 1. Here, neither D1″ or D2″ is the reflection signals by the first chirp signal generation section 211B and the second chirp signal generation section 212B. Therefore, the phase of D1″ and the phase of D2″ never match even if the number of times of speed folding is 0 or 1. For example, as illustrated in FIG. 15, there is always a phase shift of 1.1 between D1″ and D2″ regardless of the speed folding.

The fourth angle-of-arrival spectrum S4 illustrated in FIG. 15(B) is a false spectrum in a case where the number of times of speed folding is 0 or 1, and its shape barely changes. Here, as described above, “barely changes” means that its peak intensity or spectrum shape do not change (for example, more than 60% of its shape matches).

The fourth angle-of-arrival spectrum S4 illustrated in FIG. 15(B) is in a state where the timing synchronization signal 12 invades as illustrated in FIG. 11(B). Therefore, its spectrum shape barely changes even if the speed folding correction process is performed (that is, for example, in a case where the timing synchronization signal 12 from an oncoming vehicle invades, the phase of the timing synchronization signal 12 is shifted from the phases of the transmission chirp signals TX1 and TX2 transmitted from the transmission device 210, and no change is seen in its shape even when the phase is rotated).

Therefore, on the basis of the third determination according to the present embodiment, the fourth angle-of-arrival spectrum S4 illustrated in FIG. 15(B) has similar shapes (false spectrum shapes) between a case where the number of times of speed folding is zero and a case where the number of times of speed folding is 1. This means that there is no angle-of-arrival spectrum having the second peak P2 whose intensity is a predetermined intensity or less than the intensity of the first peak P1. Accordingly, it is determined that the unwanted signal exists.

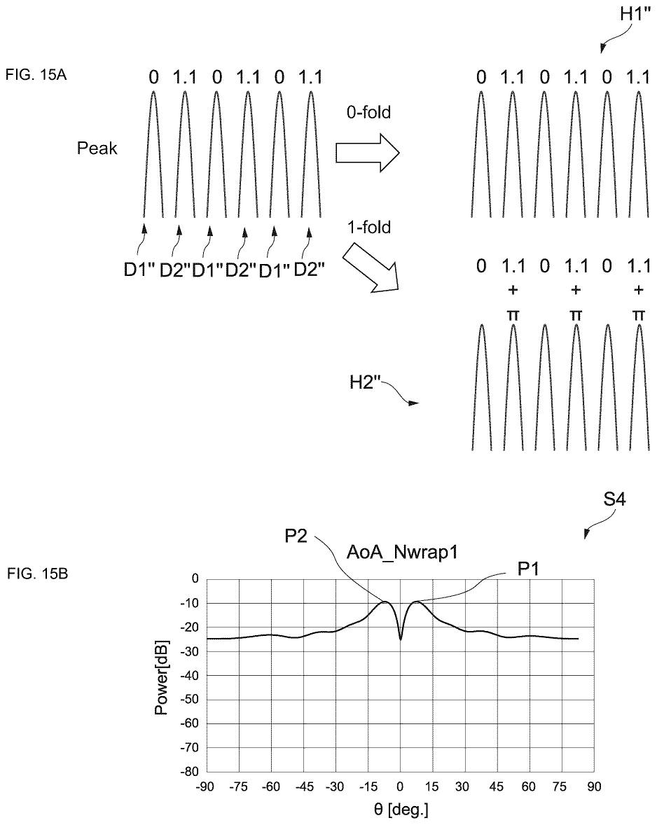

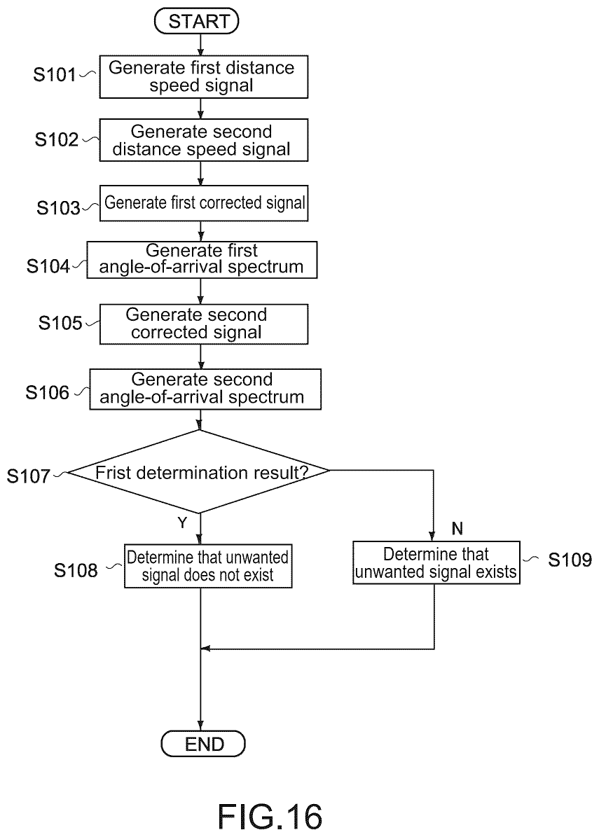

Next, a flow of determining whether the unwanted signal exists according to the present embodiment will be described with reference to a flowchart. FIG. 16 is the flowchart illustrating a process procedure of determination of the unwanted signal according to the present embodiment. The flowchart focuses on the case illustrated in FIG. 11(A).

First, the transform process section 222B executes the Fourier transform with regard to the first beat signal generated by the beat signal generation section 221B on the basis of the first transmission chirp signal TX1 and the first reflection chirp signal RX1, and generates the first distance speed signal D1 (Step S101).

Next, the transform process section 22B executes the Fourier transform with regard to the second beat signal generated by the beat signal generation section 221B on the basis of the second transmission chirp signal TX2 and the second reflection chirp signal RX2, and generates the second distance speed signal D2 (Step S102).

Next, the folding correction section 23B executes a correction process with the number of times of speed folding=0 with regard to the first distance speed signal D1 and the second distance speed signal D2 (in other words, the phase is not corrected), and generates the first corrected signal H1 (Step S103).

Next, the angle-of-arrival information generation section 24B performs the AoA (Fourier transform) with regard to the first corrected signal D1, and generates the first angle-of-arrival spectrum S1 (Step S104).

Next, the folding correction section 23B executes a correction process with the number of times of speed folding=1 with regard to the first distance speed signal D1 and the second distance speed signal D2 (in other words, the phase is corrected), and generates the second corrected signal H2 (Step S105).

Next, the angle-of-arrival information generation section 24B performs the AoA (Fourier transform) with regard to the second corrected signal H2, and generates the second angle-of-arrival spectrum S2 (Step S106).

The determination section 25B compares the first angle-of-arrival spectrum S1 with the second angle-of-arrival spectrum S2 and determines whether the above-described first determination result is obtained (Step S107).

If YES in Step S107, it is determined that no unwanted signal exists and the object 300 is a target that is actually present (Step S108). In other words, the result of Step S107 becomes YES in a case of FIG. 11(A). If No in Step S107, the second determination result or the third determination result is obtained, and it is determined that the unwanted signal due to the parallel interference or the multipath exists (Step S109). In other words, in a case of FIG. 11(B) or FIG. 11(C), the result of Step S107 becomes NO, the second determination result or the third determination result is obtained, and it is determined that the unwanted signal exists.

The determination device 220 according to the present embodiment determines whether the unwanted signal exists by using the angle-of-arrival spectrum calculated for detecting (estimating) a speed (relative speed) of angle of the object 300 with respect to the reception section (determination device 220 or radar device 200).

Accordingly, it is possible to determine whether the unwanted signal exists with regard to the received reflection chirp signals through the procedure of detecting (estimating) the angle of the object 300 without preparing the special mode for determining presence or absence of the interference (unwanted signal) or without increasing the noise floor. This makes it possible to efficiently determine the unwanted signal at low cost.

### Modification

In the above embodiment, the example in which the different transmission antennas (first transmission antenna 101A and second transmission antenna 102A) transmit the transmission chirp signals in the time-division manner has been described. However, the present technology is not limited thereto. The transmission chirp signals may be transmitted from a single transmission antenna in a phase-division manner.

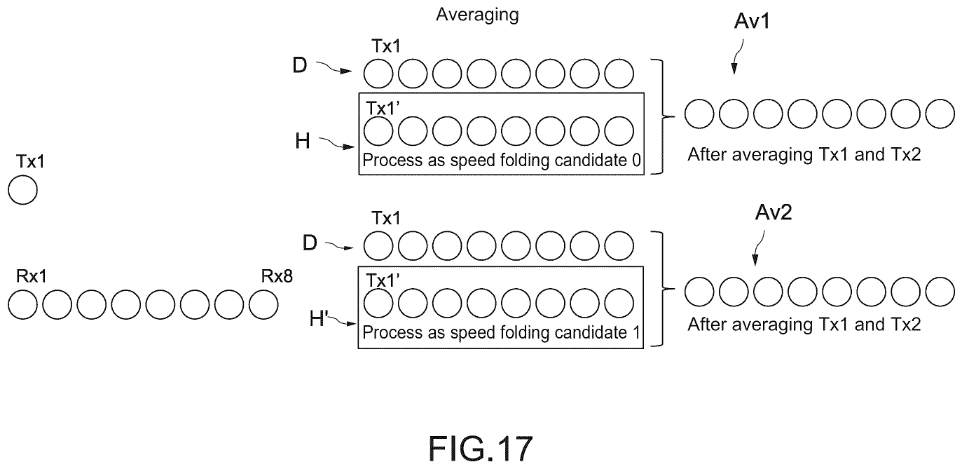

In this case, as illustrated in FIG. 17, a process of averaging a first corrected signal H obtained by performing the speed folding zero times on a distance speed signal D and a distance speed signal D to generate a first averaged signal Av1 is executed. In addition, a process of averaging a second corrected signal H′ obtained by performing the speed folding once on the distance speed signal D and the distance speed signal D to generate a second averaged signal Av2 is executed.

Here, “averaging” means a process of averaging phases of the first corrected signal H′ and the distance speed signal D. For example, in a case where the phase of the first corrected signal H′ corrected through the speed folding is shifted from the phase of the distance speed signal D by +π, an averaging process shifts the phase of the first averaged signal Av1 from the phase of the distance speed signal D by +α/2.

Next, the AoA is performed on the first averaged signal Av1 in a way similar to Step S104 described above, and the AoA is also performed on the second averaged signal Av2 in a way similar to Step S106 described above.

Next, processes similar to Step S107 to Step S109 described above are performed. This makes it possible to achieve effects similar to the above-described effects without preparing the plurality of transmission antennas.

### Another Modification

In the above-described embodiment, the horizontal MIMO has been used. However, the present technology is not limited thereto, and may use the vertical MIMO. Also, FIG. 11(B) illustrates the cases where the unwanted signal is a signal based on the single-input multiple-output (SIMO). Of course, the present technology is not limited thereto. For example, the oncoming vehicle may use the MIMO and a signal based on the MIMO may invade. It is also possible to determine whether the unwanted signal exists even in this case. Also, in the present embodiment, the speed folding correction process (to correct phase) has been performed on the second distance speed signal D2. Of course, the present technology is not limited thereto, and the speed folding correction process may be performed on the first distance speed signal D1.

Also, in the present embodiment, it has been determined whether it is a correct spectrum on the basis of a difference between the reception intensity of the first peak P1 and the reception intensity of the second peak P2. Of course, the present technology is not limited thereto, and it is also possible to make a determination on the basis of whether a rate of concordance between angle-of-arrival spectra is a predetermined value (for example, 60%) or more.

In other words, in a case where the rate of concordance between a plurality of angle-of-arrival spectra is the predetermined value or less (corresponding to Fig. according to the present embodiment), it is determined that no unwanted signal exists. In a case where the rate of concordance between a plurality of angle-of-arrival spectra is more than the predetermined value, it is determined that the unwanted signal exists. Subsequently, it is possible to determine that the correct spectrum is obtained in a case where the difference in reception intensity between the first peak P1 and the second peak P2 is a predetermined value or more among the plurality of angle-of-arrival spectra for which it is determined that no unwanted signal exists as described above.

In addition, in the present embodiment, the number of times of the speed folding correction process is 0 or 1. However, the present technology is not limited thereto. The number of times of the speed folding correction process may be 0 or two or more. In other words, in the present embodiment, the range of the phase correction is expanded from a range from −π to +π to a range from −2π to +2π. Also, it becomes possible to expand the number of times of the speed folding correction process (the number of times of folding) to 2 or 3 by further expanding the phase correction range.

### <<1. Configuration Example of Vehicle Control System>>

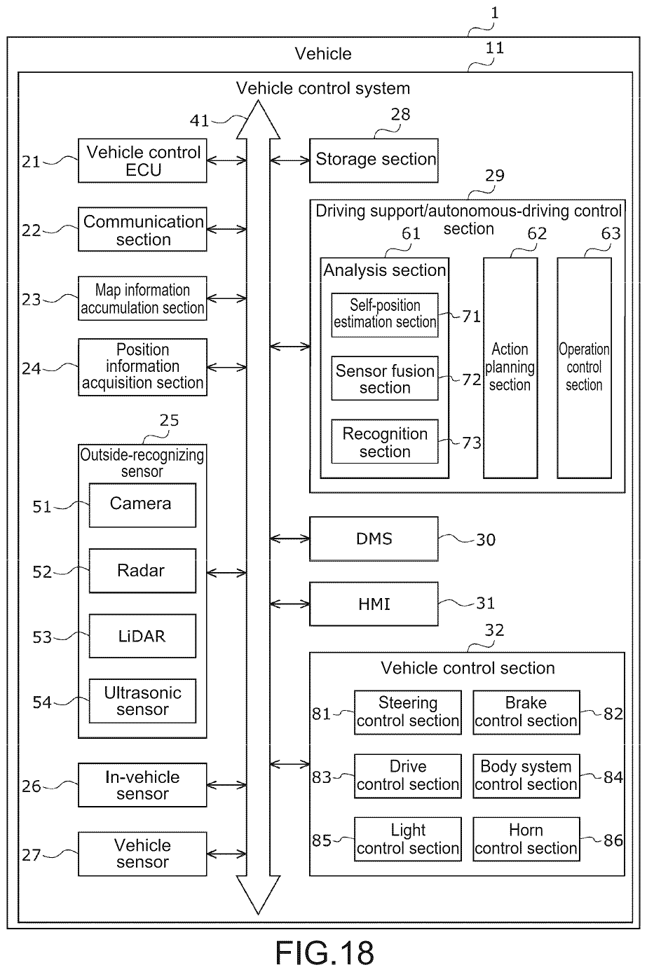

FIG. 18 is a block diagram illustrating a configuration example of a vehicle control system 11 that is an example of a moving device control system to which the present technology is applied.

The vehicle control system 11 is provided in a vehicle 1 and performs processes relating to automated driving of the vehicle 1. This automated driving includes automated driving at levels 1 to 5 and remote driving and remote assistance of the vehicle 1 by a remote driver.

The vehicle control system 11 includes a vehicle control electronic control section (ECU) 21, a communication section 22, a map information accumulation section 23, a position information acquisition section 24, an outside-recognizing sensor 25, an in-vehicle sensor 26, a vehicle sensor 27, a storage section 28, a driving automation control section 29, a driver monitoring system (DMS) 30, a human machine interface (HMI) 31, and a vehicle control section 32.

The vehicle control ECU 21, the communication section 22, the map information accumulation section 23, the position information acquisition section 24, the outside-recognizing sensor 25, the in-vehicle sensor 26, the vehicle sensor 27, the storage section 28, the driving automation control section 29, the DMS 30, the HMI 31, and the vehicle control section 32 are communicably connected to each other via a communication network 41. The communication network 41 includes an in-vehicle communication network, a bus, or the like conforming to the digital bidirectional communication standard such as a controller area network (CAN), a local interconnect network (LIN), a local area network (LAN), FlexRay (registered trademark), and Ethernet (registered trademark). The communication network 41 may be used properly depending on the type of data to be transmitted. For example, CAN may be applied for data relating to vehicle control and Ethernet may be applied for large-capacity data. Note that the respective sections of the vehicle control system 11 are directly connected to each other using wireless communication assuming relatively short-distance communication, such as near field communication (NFC) and Bluetooth (registered trademark) without the communication network 41 in some cases.

Note that hereinafter, in the case where the respective sections of the vehicle control system 11 communicate with each other via the communication network 41, description of the communication network 41 will be omitted. For example, in the case where the vehicle control ECU 21 and the communication section 22 communicate with each other via the communication network 41, it is described that the vehicle control ECU 21 and the communication section 22 are communicated with each other.

The vehicle control ECU 21 includes various processors such as a central processing section (CPU) and a micro processing section (MPU). The vehicle control ECU 21 controls the functions of the entire vehicle control system 11 or part thereof.

The communication section 22 communicates with various devices inside and outside the vehicle, another vehicle, a server, a base station, and the like, and transmits/receives various types of data. At this time, the communication section 22 is capable of performing communication using a plurality of communication methods.

The communication with the outside, which can be executed by the communication section 22, will be schematically described. The communication section 22 communicates with a server present on an external network (hereinafter, referred to as the external server) or the like via a base station or an access point by a wireless communication method such as 5th generation mobile communication system (5G), long-term evolution (LTE), and dedicated short-range communications (DSRC). The external network with which the communication section 22 communicates is, for example, the Internet, a cloud network, or a network unique to a business operator. The communication method of the communication performed by the communication section 22 with the external network is not particularly limited as long as it is a wireless communication method capable of performing digital bidirectional communication at a predetermined communication speed or more and a predetermined distance or more.

Further, for example, the communication section 22 is capable of communicating with a terminal present in the vicinity of the own vehicle using a peer-to-peer (P2P) technology. The terminal present in the vicinity of the own vehicle is, for example, a terminal worn by a moving object that moves at a relatively low speed such as a pedestrian and a bicycle, a terminal installed at a fixed position in a store or the like, or a machine type communication (MTC) terminal. Further, the communication section 22 is capable of performing V2X communication. The V2X communication is communication between the own vehicle and others such as vehicle-to-vehicle communication with another vehicle, vehicle-to-infrastructure communication with a roadside device or the like, vehicle-to-home communication with a home, and vehicle-to-pedestrian communication with a terminal owned by a pedestrian.

The communication section 22 is capable of receiving, from the outside, a program for updating software that controls the operation of the vehicle control system 11, for example (over-the-air). The communication section 22 is capable of further receiving, from the outside, map information, traffic information, information around the vehicle 1, and the like. Further, for example, the communication section 22 is capable of transmitting, to the outside, information relating to the vehicle 1 or information around the vehicle 1. Examples of the information relating to the vehicle 1 transmitted by the communication section 22 to the outside include data indicating the state of the vehicle 1 and the recognition result by a recognition section 73.

Further, for example, the communication section 22 performs communication corresponding to the vehicle emergency call system such as ecall.

For example, the communication section 22 receives electromagnetic waves transmitted by vehicle information and communication system (VICS) (registered trademark) including a radio wave beacon, an optical beacon, and FM multiplex broadcasting.

The in-vehicle communication that can be executed by the communication section 22 will be schematically described. The communication section 22 is capable of communicating with each device in the vehicle using, for example, wireless communication. The communication section 22 is capable of performing wireless communication with the device in the vehicle by a communication method capable of performing digital bidirectional communication at a predetermined communication speed or more by wireless communication such as a wireless LAN, Bluetooth, NFC, and Wireless USB (WUSB). The present disclosure is not limited thereto, and the communication section 22 is capable of communicating with each device in the vehicle using wired communication. For example, the communication section 22 is capable of communicating with each device in the vehicle by wired communication via a cable connected to a connection terminal (not shown). The communication section 22 is capable of communicating with each device in the vehicle by a communication method capable of performing digital bidirectional communication at a predetermined communication speed or more by wired communication such as Universal Serial Bus (USB), HDMI (registered trademark) (High-Definition Multimedia Interface), and Mobile High-definition Link (MHL).

Here, the device in the vehicle represents, for example, a device that is not connected to the communication network 41 in the vehicle. As the device in the vehicle, for example, a mobile device or wearable device owned by a user in the vehicle such as a driver, an information device that is brought into the vehicle and temporarily installed, and the like are assumed.

The map information accumulation section 23 accumulates one or both of the map acquired from the outside and the map created by the vehicle 1. For example, the map information accumulation section 23 accumulates a three-dimensional high-precision map, a global map that has precision lower than that of the high-precision map but covers a wider area, and the like.

The high-precision map is, for example, a dynamic map, a point cloud map, or a vector map. The dynamic map is, for example, a map including four layers of dynamic information, quasi-dynamic information, quasi-static information, and static information, and is provided from the external server or the like to the vehicle 1. The point cloud map is a map including point clouds (point cloud data). The vector map is, for example, a map conforming to ADAS (Advanced Driver Assistance System) or AD (Autonomous Driving), in which traffic information such as lanes and positions of traffic lights is associated with a point cloud map.

The point cloud map and the vector map may be provided from, for example, the external server, or may be created by the vehicle 1 on the basis of the sensing result by a camera 51, a radar 52, a LiDAR 53, and the like as a map for matching with a local map described below and accumulated in the map information accumulation section 23. Further, in the case where a high-precision map is provided from the external server or the like, for example, map data of several hundred meters square relating to the planned route through which the vehicle 1 will travel is acquired from the external server or the like in order to reduce the communication capacity.

The position information acquisition section 24 receives a GNSS signal from a GNSS (Global Navigation Satellite System) satellite to acquire position information of the vehicle 1. The received position information is supplied to the driving automation control section 29. Note that the position information acquisition section 24 does not necessary use the method using a GNSS signal and may acquire position information using a beacon, for example.

The outside-recognizing sensor 25 includes various sensors used for recognizing the external situation of the vehicle 1 and supplies sensor data from each sensor to the respective sections of the vehicle control system 11. The type and number of the sensors included in the outside-recognizing sensor 25 are arbitrary.

For example, the outside-recognizing sensor 25 includes the camera 51, the radar 52, the LiDAR (Light Detection and Ranging, Laser Imaging Detection and Ranging) 53, and an ultrasonic sensor 54. The present disclosure is not limited thereto, and the outside-recognizing sensor 25 may include one or more of sensors of the camera 51, the radar 52, the LiDAR 53, and the ultrasonic sensor 54. The numbers of cameras 51, radars 52, LiDARs 53, and ultrasonic sensors 54 are not particularly limited as long as they can be practically installed in the vehicle 1. Further, the type of the sensor included in the outside-recognizing sensor 25 is not limited to this example, and the outside-recognizing sensor 25 may include other types of sensors. An example of the sensing region of each sensor included in the outside-recognizing sensor 25 will be described below.

Note that the imaging method of the camera 51 is not particularly limited. For example, as the camera 51, a camera of various imaging methods capable of performing distance measurement, such as a time-of flight (ToF) camera, a stereo camera, a monocular camera, and an infrared camera, can be applied as necessary. The present disclosure is not limited thereto, and the camera 51 does not necessarily perform distance measurement and may be for simply acquiring a captured image.

Further, for example, the outside-recognizing sensor 25 may include an environment sensor for detecting the environment for the vehicle 1. The environment sensor is a sensor for detecting the environment including weather, climate, and brightness, and may include various sensors such as a raindrop sensor, a fog sensor, a sunshine sensor, a snow sensor, and an illuminance sensor.

Further, for example, the outside-recognizing sensor 25 includes a microphone used for, for example, detecting sound around the vehicle 1 and the position of the sound source.

The in-vehicle sensor 26 includes various sensors for detecting in-vehicle information, and supplies sensor data from each sensor to the respective sections of the vehicle control system 11. The type and number of various sensors included in the in-vehicle sensor 26 are not particularly limited as long as they can be practically installed in the vehicle 1.

For example, the in-vehicle sensor 26 may include one or more sensors of a camera, a radar, a seating sensor, a steering wheel sensor, a microphone, and a biosensor. As the camera included in the in-vehicle sensor 26, for example, a camera of various imaging methods capable of performing distance measurement, such as a ToF camera, a stereo camera, a monocular camera, and an infrared camera, can be used.

The present disclosure is not limited thereto, and the camera included in the in-vehicle sensor 26 does not necessarily perform distance measurement and may be for simply acquiring a captured image. The biosensor included in the in-vehicle sensor 26 is provided on, for example, a seat or a steering wheel, and detects various types of biometric information of the user.

The vehicle sensor 27 includes various sensors for detecting the state of the vehicle 1 and supplies sensor data from each sensor to the respective sections of the vehicle control system 11. The type and number of various sensors included in the vehicle sensor 27 are not particularly limited as long as they can be practically installed in the vehicle 1.

For example, the vehicle sensor 27 includes a speed sensor, an acceleration sensor, an angular velocity sensor (gyro sensor), and an inertial measurement section (IMU) that integrates them. For example, the vehicle sensor 27 includes a steering angle sensor that detects the steering angle of a steering wheel, a yaw rate sensor, an accelerator sensor that detects the amount of operation of an accelerator pedal, and a brake sensor that detects the amount of operation of a brake pedal. For example, the vehicle sensor 27 includes a rotation sensor that detects the RPM of an engine or a motor, a pneumatic sensor that detects a tire pressure, a slip rate sensor that detects the slip rate of a tire, and a wheel speed sensor that detects the rotation speed of a wheel. For example, the vehicle sensor 27 includes a battery sensor that detects the remaining amount and temperature of a battery and an impact sensor that detects the impact from the outside.

The storage section 28 includes at least one of a non-volatile storage medium or a volatile storage medium, and stores data and a program. The storage section 28 is used as, for example, an EEPROM (electrically erasable programmable read-only memory) and a random-access memory (RAM). As a storage medium, a magnetic storage device such as a hard disk drive (HDD), a semiconductor storage device, an optical storage device, and a magneto-optical storage device are applicable. The storage section 28 stores various programs and data used by the respective sections of the vehicle control system 11. For example, the storage section 28 includes an event data recorder (EDR) and a Data Storage System for Automated Driving (DSSAD), and stores information regarding the vehicle 1 before and after an event such as an accident and information acquired by the in-vehicle sensor 26.

The driving automation control section 29 controls an automated driving function of the vehicle 1. For example, the driving automation control section 29 includes an analysis section 61, an action planning section 62, and an operation control section 63.

The analysis section 61 performs processing of analyzing the vehicle 1 and the surrounding situation. The analysis section 61 includes a self-position estimation section 71, a sensor fusion section 72, and the recognition section 73.

The self-position estimation section 71 estimates the self-position of the vehicle 1 on the basis of the sensor data from the outside-recognizing sensor 25 and the high-precision map accumulated in the map information accumulation section 23. For example, the self-position estimation section 71 generates a local map on the basis of the sensor data from the outside-recognizing sensor 25, and matches the local map with the high-precision map to estimate the self-position of the vehicle 1. The position of the vehicle 1 is based on, for example, the center of the rear wheel-to-axle.

The local map is, for example, a three-dimensional high-precision map or an occupancy grid map created using a technology such as simultaneous localization and mapping (SLAM). The three-dimensional high-precision map is, for example, the above-mentioned point cloud map. The occupancy grid map is a map that is obtained by dividing a three-dimensional or two-dimensional space around the vehicle 1 into grids of a predetermined size and shows the occupied state of an object in units of grids. The occupied state of an object is shown by, for example, the presence or absence of the object or the probability of presence.

The local map is also used by, for example, the recognition section 73 for detecting and recognizing the external situation of the vehicle 1.

Note that the self-position estimation section 71 may estimate the self-position of the vehicle 1 on the basis of the position information acquired by the position information acquisition section 24 and the sensor data from the vehicle sensor 27.

The sensor fusion section 72 performs sensor fusion processing of acquiring information by combining a plurality of different types of sensor data (e.g., the image data supplied from the camera 51 and the sensor data supplied from the radar 52). Examples of the method of combining different types of sensor data include composition, integration, fusion, and association.

The recognition section 73 executes detection processing of detecting the external situation of the vehicle 1 and recognition processing of recognizing the external situation of the vehicle 1.

For example, the recognition section 73 performs the detection processing and recognition processing of the external situation of the vehicle 1 on the basis of information from the outside-recognizing sensor 25, information from the self-position estimation section 71, information from the sensor fusion section 72, or the like.

Specifically, for example, the recognition section 73 performs detection processing and recognition processing of an object around the vehicle 1. The detection processing of an object is, for example, processing of detecting the presence or absence of an object, or the size, shape, position, and movement of the object. The recognition processing of an object is, for example, processing of recognizing the attribute of an object such as a type or identifying a specific object. However, the detection processing and the recognition processing are not necessarily clearly separated from each other and Overlap with each other in some cases.

For example, the recognition section 73 detects an object around the vehicle 1 by performing clustering for classifying point clouds based on the sensor data acquired by the radar 52, the LiDAR 53, or the like into each block of point clouds. As a result, the presence or absence of an object around the vehicle 1, and the size, shape, and position of the object are detected.

For example, the recognition section 73 detects the movement of an object around the vehicle 1 by performing tracking for following the movement of the block of point clouds classified by the clustering. As a result, the speed and the traveling direction (movement vector) of the object around the vehicle 1 are detected.

For example, the recognition section 73 detects or recognizes, on the basis of the image data supplied from the camera 51, a vehicle, a person, a bicycle, an obstacle, a structure, a road, a traffic light, a traffic sign, a road sign, and the like.

Further, the type of an object around the vehicle 1 may be recognized by performing recognition processing such as semantic segmentation.

For example, the recognition section 73 is capable of performing processing of recognizing traffic rules around the vehicle 1 on the basis of the map accumulated in the map information accumulation section 23, the estimation result of the self-position by the self-position estimation section 71, and the recognition result of an object around the vehicle 1 by the recognition section 73. The recognition section 73 is capable of recognizing, by this processing, the position and state of the traffic light, the content of the traffic sign and road sign, the content of the traffic regulation, the lane in which the vehicle is capable of traveling, and the like.

For example, the recognition section 73 is capable of performing recognition processing of the surrounding environment of the vehicle 1. As the surrounding environment to be recognized by the recognition section 73, the weather, temperature, humidity, brightness, the state of a road surface, and the like are assumed.

The action planning section 62 creates an action plan of the vehicle 1. For example, the action planning section 62 creates an action plan by performing processing of route planning and route tracking. The action planning section 62 creates an action plan of the vehicle 1.

Note that the route planning includes global path planning and local path planning. The global path planning is processing of planning a rough route from a start to a goal. The local path planning includes processing of trajectory generation called trajectory planning, the vehicle 1 being capable of safely and smoothly traveling through the trajectory in the vicinity of the vehicle 1 in the route planned in the route planning considering the kinetic characteristics of the vehicle 1.

The route tracking is processing of planning an operation for safely and accurately traveling on a route planned by the route planning within a planned time. The action planning section 62 is capable of, for example, calculating the target speed and the target angular velocity of the vehicle 1 on the basis of the result of the route tracking processing.

The operation control section 63 controls the operation of the vehicle 1 in order to realize the action plan created by the action planning section 62.

For example, the operation control section 63 controls a steering control section 81, a brake control section 82, and a drive control section 83 included in the vehicle control section 32 described below to perform lateral-direction vehicle motion control and longitudinal-direction vehicle motion control such that the vehicle 1 travels through the trajectory calculated by the trajectory planning. For example, the operation control section 63 performs control for the purpose of driving automation such as traveling without operations performed by the driver or the remote driver, and driver assistance functions like collision avoidance, impact mitigation, follow-up driving, vehicle-speed maintaining driving, collision warning of the own vehicle, and lane deviation warning of the own vehicle.

The DMS 30 performs authentication processing of the driver, recognition processing of the state of the driver, and the like, on the basis of the sensor data from the in-vehicle sensor 26, the input data input to the HMI 31 described below, and the like. As the state of the driver to be recognized, for example, the physical condition, the degree of alertness, the degree of concentration, the degree of fatigue, the 60 gaze direction, the degree of drunkenness, the driving operation, and the posture are assumed.

Note that the DMS 30 may perform the authentication processing of users other than the driver and the recognition processing of the state of the users. Further, for example, the DMS 30 may perform the recognition processing of the situation in the vehicle on the basis of the sensor data from the in-vehicle sensor 26. As the situation in the vehicle to be recognized, for example, temperature, humidity, brightness, odor, and the like are assumed.

The HMI 31 inputs various types of data and instructions, and presents various types of data to the users.

The input of data by the HMI 31 will be schematically described. The HMI 31 includes an input device for a person to input data. The HMI 31 generates an input signal on the basis of the data and instruction input by the input device, and supplies the input signal to the respective sections of the vehicle control system 11. The HMI 31 includes, as an input device, an operator such as a touch panel, a button, a switch, and a lever. The present disclosure is not limited thereto, and the HMI 31 may further include an input device capable of inputting information by a method other than the manual operation, e.g., voice or gesture. Further, for example, the HMI 31 may use, as an input device, a remote control device using infrared rays or radio waves, or an externally-connected device such as a movable device and a wearable device that support the operation of the vehicle control system 11.

The presentation of data by the HMI 31 will be schematically described. The HMI 31 generates visual information, auditory information, and haptic information for the users or the outside of the vehicle. Further, the HMI 31 performs output control of controlling the output, the output content, the output timing, and the output method of these pieces of generated information. The HMI 31 generates and outputs, as the visual information, an image or information indicated by light such as an operation screen, the state display of the vehicle 1, warning display, and a monitor image indicating the situation around the vehicle 1. Further, the HMI 31 generates and outputs, as the auditory information, information indicated by sounds such as voice guidance, a warning sound, and a warning message. Further, the HMI 31 generates and outputs, as the haptic information, information given to the haptic sensation of the users by, for example, force, vibration, or movement.

As the output device by which the HMI 31 outputs the visual information, for example, a display device that presents visual information by displaying an image by itself or a projector device that presents visual information by projecting an image can be applied. Note that the display device does not necessarily need to be a display device including a normal display and may be a device that displays visual information within the field of view of the user, such as a head-up display, a transmissive display, and a wearable device having an augmented reality (AR) function. Further, the HMI 31 may use, as an output device that outputs visual information, a display device included in a navigation device, an instrument panel, a camera monitoring system (CMS), an electronic mirror, a lamp, or the like provided in the vehicle 1.

As an output device by which the HMI 31 outputs auditory information, for example, an audio speaker, a headphone, or an earphone can be applied.

As an output device by which the HMI 31 outputs haptic information, for example, a haptic device using a haptic technology can be applied. The haptic device is provided at a portion of the vehicle 1 that the users touch, such as a steering wheel and a seat.

The vehicle control section 32 controls the respective sections of the vehicle 1. The vehicle control section 32 includes the steering control section 81, the brake control section 82, the drive control section 83, a body system control section 84, a light control section 85, and a horn control section 86.

The steering control section 81 detects and controls the state of the steering system of the vehicle 1, for example. The steering system includes, for example, a steering mechanism including a steering wheel and the like, an electric power steering, and the like. The steering control section 81 includes, for example, a steering ECU that controls the steering system, an actuator that drives the steering system, and the like.

The brake control section 82 detects and controls the state of the brake system of the vehicle 1, for example. The brake system includes, for example, a brake mechanism including a brake pedal and the like, an anti-lock braking system (ABS), a regenerative brake mechanism, and the like. The brake control section 82 includes, for example, a brake ECU that controls the brake system, an actuator that drives the brake system, and the like.

The drive control section 83 detects and controls the state of the drive system of the vehicle 1, for example. The drive system includes, for example, a drive-force generating device for generating a drive force, such as an accelerator pedal, an internal combustion engine, and a drive motor, a drive-force transmission mechanism for transmitting a drive force to wheels, and the like. The drive control section 83 includes, for example, a drive ECU that controls the drive system, an actuator that drives the drive system, and the like.

The body system control section 84 detects and controls the state of the body system of the vehicle 1, for example. The body system includes, for example, a keyless entry system, a smart key system, a power window device, a power seat, an air conditioner, an airbag, a seat belt, a shift lever, and the like. The body system control section 84 includes, for example, a body system ECU that controls the body system, an actuator that drives the body system, and the like.

The light control section 85 detects and controls the state of various lights of the vehicle 1.

As the light to be controlled, for example, a headlight, a backlight, a fog light, a turn signal, a brake light, a projection, a bumper display, and the like are assumed. The light control section 85 includes a light ECU that controls the light, an actuator that drives the light, and the like.

The horn control section 86 detects and controls the state of a car horn of the vehicle 1, for example. The horn control section 86 includes, for example, a horn ECU that controls the car horn, an actuator that drives the car horn, and the like.

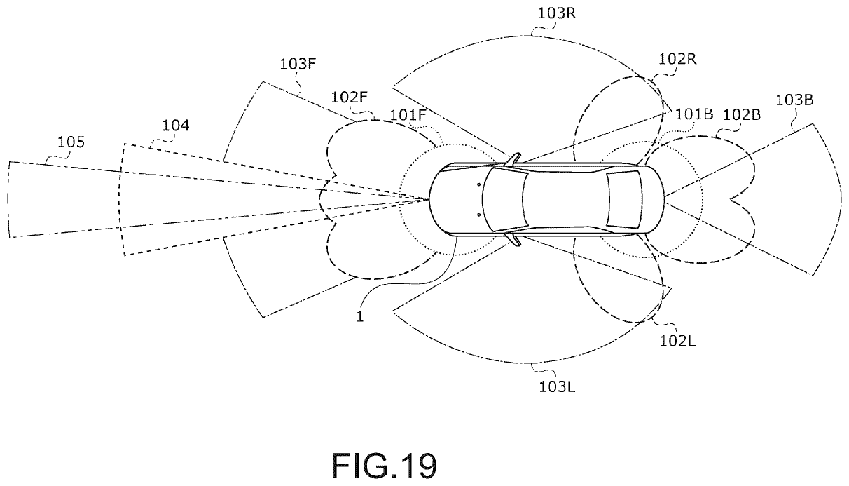

FIG. 19 is a diagram showing an example of a sensing region of the camera 51, the radar 52, the LiDAR 53, the ultrasonic sensor 54, and the like of the outside-recognizing sensor 25 shown in FIG. 18. Note that in FIG. 19, a state of the vehicle 1 viewed from the upper surface is schematically shown, the left end side is the front end (front) side of the vehicle 1, and the right end side is the rear end (rear) side of the vehicle 1.

A sensing region 101F and a sensing region 101B each show an example of the sensing region of the ultrasonic sensor 54. The sensing region 101F covers the periphery of the front end of the vehicle 1 by the plurality of ultrasonic sensors 54. The sensing region 101B covers the periphery of the rear end of the vehicle 1 by the plurality of ultrasonic sensors 54.

The sensing results in the sensing region 101F and the sensing region 101B are used for, for example, parking support of the vehicle 1.

A sensing region 102F to a sensing region 102B each show an example of the sensing region of the radar 52 for a short distance or middle distance. The sensing region 102F covers a range to a position farther than the sensing region 101F in front of the vehicle 1. The sensing region 102B covers a range to a position farther than the sensing region 101B behind the vehicle 1. The sensing region 102L covers the rear periphery of the vehicle 1 on the left side surface. The sensing region 102R covers the rear periphery of the vehicle 1 on the right side surface.

The sensing result in the sensing region 102F is used for, for example, detecting a vehicle or a pedestrian present in front of the vehicle 1. The sensing result in the sensing region 102B is used for, for example, a function of preventing collision behind the vehicle 1. The sensing results in the sensing region 102L and the sensing region 102R are used for, for example, detecting an object in a blind spot on the side of the vehicle 1.

A sensing region 103F to a sensing region 103B each show an example of the sensing region of the Camera 51. The sensing region 103F covers a range to a position farther than the sensing region 102F in front of the vehicle 1. The sensing region 103B covers a range to a position farther than the sensing region 102B behind the vehicle 1. The sensing region 103L covers the periphery of the vehicle 1 on the left side surface. The sensing region 103R covers the periphery of the vehicle 1 on the right side surface.

The sensing result in the sensing region 103F can be used for, for example, recognition of a traffic light and a traffic sign, a lane deviation prevention support system, or an automatic headlight control system. The sensing result in the sensing region 103B can be used for, for example, parking support and a surround view system. The sensing results in the sensing region 103L and the sensing region 103R can be used for, for example, a surround view system.

A sensing region 104 shows an example of the sensing region of the LiDAR 53. The sensing region 104 covers a range to a position farther than the sensing region 103F in front of the vehicle 1. Meanwhile, the sensing region 104 has a narrower range in the right and left direction than the sensing region 103F.

The sensing result in the sensing region 104 is used for, for example, detecting an object such as a peripheral vehicle.

A sensing region 105 shows an example of the sensing region of the radar 52 for a long distance. The sensing region 105 covers a range to a position farther than the sensing region 104 in front of the vehicle 1. Meanwhile, the sensing region 105 has a narrower range in the right and left direction than the sensing region 104.

The sensing result in the sensing region 105 is used for, for example, adaptive cruise control (ACC), emergency brake, collision avoidance.

Note that the sensing region of each sensor of the camera 51, the radar 52, the LiDAR 53, and the ultrasonic sensor 54 included in the outside-recognizing sensor 25 may have various configurations other than that shown in FIG. 2. Specifically, the ultrasonic sensor 54 may sense also the side of the vehicle 1, or the LiDAR 53 may sense the rear of the vehicle 1. Further, the installation position of each sensor is not limited to each of the above-mentioned examples. Further, the number of sensors may be one or two or more.

The radar device 200 according to the present disclosure is applicable to the radar 52 of the outside-recognizing sensor 25 in the in-vehicle control system 11 described above. The radar device 200 according to the present disclosure may determines whether an unwanted wave is generated such as radio wave interference. In a case where it is determined that the unwanted wave is generated, the user of the vehicle 1 may be notified that the radar device 200 may not behave appropriately. Alternatively, in the case where it is determined that the unwanted wave is generated, the in-vehicle control system 11 may limit a portion or all of the driving automation functions that behave on the basis of sensing results obtained by the radar device 200.

The present disclosure may also take the following configurations.
(1)

A determination device, including:
a reception section configured to receive a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
a determination process section configured to generate a plurality of angle-of-arrival spectra on the basis of a plurality of corrected signals obtained by performing a plurality of speed folding correction processes on the first reflection chirp signal and the second reflection chirp signal that have been received by the reception section, compare the plurality angle-of-arrival spectra with each other, and determine whether or not an unwanted signal is received.
(2)

The determination device according to (1), in which
the determination process section includes a beat signal generation section configured to generate a first beat signal on the basis of the first transmission chirp signal and the first reflection chirp signal, and generate a second beat signal on the basis of the second transmission chirp signal and the second reflection chirp signal.
(3)

The determination device according to (1) or (2), in which
the determination process section includes a transform process section configured to generate a first distance speed signal including a first distance signal related to a distance to the object and a first speed signal related to speed of the object by executing a Fourier transform process on the basis of the first reflection chirp signal, and a second distance speed signal including a second distance signal related to a distance to the object and a second speed signal related to speed of the object by executing the Fourier transform process on the basis of the second reflection chirp signal.
(4)

The determination device according to any one of (1) to (3), in which
the determination process section includes
   a determination section configured to determine that the unwanted signal does not exist in a case where the plurality angle-of-arrival spectra includes only one angle-of-arrival spectrum having second peak intensity that is a predetermined intensity or less with respect to first peak intensity, and determine that the unwanted signal exists in a case where the plurality of angle-of-arrival spectra includes a plurality of angle-of-arrival spectra having the second peak intensities that are the predetermined intensity or less with respect to the first peak intensity and in a case where the plurality of angle-of-arrival spectra does not include the angle-of arrival spectrum having the second peak intensity that is the predetermined intensity or less with respect to the first peak intensity, the first peak intensity achieving maximum reception intensity with respect to angles of arrival of the first reflection chirp signal and the second reflection chirp signal, the second peak achieving a second highest reception intensity after the first peak.
(5)

The determination device according to any one of (1) to (4), in Which

the unwanted signal is an interference signal transmitted from another transmission device different from the transmission device.
(6)

The determination device according to any one of (1) to (5), in which
the unwanted signal is a signal obtained when the first transmission chirp signal transmitted from the transmission device is reflected by the object and also reflected by another object different from the object.
(7)

A determination method, including:
receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
generating a plurality of angle-of-arrival spectra on the basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.
(8)

A determination program, including:
a step of receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
a step of generating a plurality of angle-of arrival spectra on the basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.
(9)

A radar device, including:
a transmission device configured to transmit a first transmission chirp signal and a second transmission chirp signal that is emitted at a different time from when the first transmission chirp signal is emitted, toward an object, and
a determination device including
   a reception section configured to receive a first reflection chirp signal obtained when the object reflects the first transmission chirp signal, and a second reflection chirp signal obtained when the object reflects the second transmission chirp signal, and
   a determination process section configured to generate a plurality of angle-of-arrival spectra on the basis of a plurality of corrected signals obtained by performing a plurality of speed folding correction processes on the first reflection chirp signal and the second reflection chirp signal that have been received by the reception section, compare the plurality angle-of-arrival spectra with each other, and determine whether or not an unwanted signal is received.
(10)

The radar device according to (9), in which
the transmission device includes a first transmission antenna configured to transmit the first transmission chirp signal and a second transmission antenna configured to transmit the second transmission chirp signal.
(11)

The radar device according to (9), in which
the transmission device includes a transmission antenna configured to transmit the first transmission chirp signal and the second transmission chirp signal in a time-division manner.
(12)

The radar device according to (9), in which
the transmission device includes a transmission antenna configured to transmit the first transmission chirp signal and the second transmission chirp signal in a phase-division manner.

Although the embodiments and modifications of the present technology have been described above, it is needless to say that the present technology is not limited only to the above-mentioned embodiments and various modifications can be made without departing from the gist of the present technology.

### REFERENCE SIGNS LIST

200 radar device
210 transmission device
210A transmission antenna array
210B signal generation section
220 determination device
220A reception antenna array
220B determination process section
221B beat signal generation section
222B transform process section
223B folding correction section
224B angle-of-arrival information generation section
225B determination section
300 object

1. A determination device, comprising:
a reception section configured to receive a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
a determination process section configured to generate a plurality of angle-of-arrival spectra on a basis of a plurality of corrected signals obtained by performing a plurality of speed folding correction processes on the first reflection chirp signal and the second reflection chirp signal that have been received by the reception section, compare the plurality angle-of-arrival spectra with each other, and determine whether or not an unwanted signal is received.

2. The determination device according to claim 1, wherein
the determination process section includes a beat signal generation section configured to generate a first beat signal on a basis of the first transmission chirp signal and the first reflection chirp signal, and generate a second beat signal on a basis of the second transmission chirp signal and the second reflection chirp signal.

3. The determination device according to claim 1, wherein
the determination process section includes a transform process section configured to generate a first distance speed signal including a first distance signal related to a distance to the object and a first speed signal related to speed of the object by executing a Fourier transform process on a basis of the first reflection chirp signal, and a second distance speed signal including a second distance signal related to a distance to the object and a second speed signal related to speed of the object by executing the Fourier transform process on a basis of the second reflection chirp signal.

4. The determination device according to claim 1, wherein
the determination process section includes a determination section configured to determine that the unwanted signal does not exist in a case where the plurality angle-of-arrival spectra includes only one angle-of-arrival spectrum having second peak intensity that is a predetermined intensity or less with respect to first peak intensity, and determine that the unwanted signal exists in a case where the plurality of angle-of-arrival spectra includes a plurality of angle-of-arrival spectra having the second peak intensities that are the predetermined intensity or less with respect to the first peak intensity and in a case where the plurality of angle-of-arrival spectra does not include the angle-of arrival spectrum having the second peak intensity that is the predetermined intensity or less with respect to the first peak intensity, the first peak intensity achieving maximum reception intensity with respect to angles of arrival of the first reflection chirp signal and the second reflection chirp signal, the second peak achieving a second highest reception intensity after the first peak.

5. The determination device according to claim 1, wherein
the unwanted signal is an interference signal transmitted from another transmission device different from the transmission device.

6. The determination device according to claim 1, wherein
the unwanted signal is a signal obtained when the first transmission chirp signal transmitted from the transmission device is reflected by the object and also reflected by another object different from the object.

7. A determination method, comprising:
receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
generating a plurality of angle-of-arrival spectra on a basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.

8. A determination program, comprising:
a step of receiving a first reflection chirp signal obtained when an object reflects a first transmission chirp signal transmitted by a transmission device toward the object, and a second reflection chirp signal obtained when the object reflects a second transmission chirp signal emitted by the transmission device at a different time from when the first transmission chirp signal is emitted; and
a step of generating a plurality of angle-of arrival spectra on a basis of a plurality of corrected signals obtained by performing a plurality of speed folding correction processes on the first reflection chirp signal and the second reflection chirp signal that have been received, comparing the plurality angle-of-arrival spectra with each other, and determining whether or not an unwanted signal is received.

9. A radar device, comprising:
a transmission device configured to transmit a first transmission chirp signal and a second transmission chirp signal that is emitted at a different time from when the first transmission chirp signal is emitted, toward an object, and
a determination device including
a reception section configured to receive a first reflection chirp signal obtained when the object reflects the first transmission chirp signal, and a second reflection chirp signal obtained when the object reflects the second transmission chirp signal, and
a determination process section configured to generate a plurality of angle-of-arrival spectra on a basis of a plurality of corrected signals obtained by performing a plurality of speed folding correction processes on the first reflection chirp signal and the second reflection chirp signal that have been received by the reception section, compare the plurality angle-of-arrival spectra with each other, and determine whether or not an unwanted signal is received.

10. The radar device according to claim 9, wherein
the transmission device includes a first transmission antenna configured to transmit the first transmission chirp signal and a second transmission antenna configured to transmit the second transmission chirp signal.

11. The radar device according to claim 9, wherein
the transmission device includes a transmission antenna configured to transmit the first transmission chirp signal and the second transmission chirp signal in a time-division manner.

12. The radar device according to claim 9, wherein
the transmission device includes a transmission antenna configured to transmit the first transmission chirp signal and the second transmission chirp signal in a phase-division manner.
